(19) United States
(12) Patent Application Publication
(10) Pub. No.: US 2026/0333388 A1
(43) Pub. Date: Oct. 22, 2026

(54) METHODS AND APPARATUSES FOR PSFCH TRANSMISSION OVER UNLICENSED SPECTRUM

(71) Applicant: Lenovo (Beijing) Limited, Beijing (CN)

(72) Inventors: Haipeng Lei, Beijing (CN); Xin Guo, Beijing (CN); Xiaodong Yu, Beijing (CN); Zhennian Sun, Beijing (CN)

(73) Assignee: Lenovo (Beijing) Limited, Beijing (CN)

(21) Appl. No.: 19/110,348

(22) PCT Filed: Sep. 27, 2022
(86) PCT No.: PCT/CN2022/121718

§ 371 Date: Mar. 10, 2025

(51) Int. Cl. H04W 72/25; H04L 5/00; H04W 72/044

(52) U.S. Cl. CPC H04W 72/25; H04L 5/0055; H04W 72/044

(57) ABSTRACT

Embodiments of the present disclosure relate to methods and apparatuses for physical sidelink feedback channel (PSFCH) transmission. According to some embodiments of the disclosure, a UE may include: a transceiver configured to: receive, from a second UE, a physical sidelink shared channel (PSSCH) on one or more interlaces of a carrier in a slot of a plurality of slots, wherein the carrier includes a plurality of interlaces and the plurality of slots correspond to the same PSFCH occasion; and a processor coupled to the transceiver and configured to: determine a PSFCH resource for transmitting hybrid automatic repeat request acknowledgement (HARQ-ACK) feedback for the PSSCH, wherein the PSFCH resource is on a first RB within an RB set of the carrier; and wherein the transceiver is further configured to transmit, to the second UE, a signal on one or more RBs of first plurality of RBs and the HARQ-ACK feedback on the PSFCH resource in the PSFCH occasion, wherein the first plurality of RBs is included in the RB set and has a frequency spanning exceeding a predefined percentage of a bandwidth of the RB set.

### TECHNICAL FIELD

Embodiments of the present disclosure generally relate to wireless communication technology, and more particularly to methods and apparatuses for a PSFCH transmission over an unlicensed spectrum.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

A sidelink is a long-term evolution (LTE) feature introduced in 3rd generation partnership project (3GPP) Release 12, and enables a direct communication between proximal user equipments (UEs), in which data does not need to go through a base station (BS) or a core network. A sidelink communication system has been introduced into 3GPP 5G wireless communication technology, in which a direct link between two UEs is called a sidelink. Sidelink transmission may be performed on a licensed spectrum and/or an unlicensed spectrum.

There is a need for handling sidelink transmissions on an unlicensed spectrum.

### SUMMARY

Some embodiments of the present disclosure provide a first UE. The UE may include: a transceiver configured to: receive, from a second UE, a physical sidelink shared channel (PSSCH) on one or more interlaces of a carrier in a slot of a plurality of slots, wherein the carrier includes a plurality of interlaces and the plurality of slots correspond to the same physical sidelink feedback channel (PSFCH) occasion; and a processor coupled to the transceiver and configured to: determine a PSFCH resource for transmitting hybrid automatic repeat request acknowledgement (HARQ-ACK) feedback for the PSSCH, wherein the PSFCH resource is on a first RB within an RB set of the carrier; and wherein the transceiver is further configured to transmit, to the second UE, a signal on one or more RBs of a first plurality of RBs and the HARQ-ACK feedback on the PSFCH resource in the PSFCH occasion, wherein the first plurality of RBs is included in the RB set and has a frequency spanning exceeding a predefined percentage of a bandwidth of the RB set.

In some embodiments of the present disclosure, the first interlace is a predefined interlace of the one or more interlaces.

In some embodiments of the present disclosure, the first plurality of RBs is configured by radio resource control (RRC) signaling or predefined.

Some embodiments of the present disclosure provide a second UE. The second UE may include: a transceiver configured to: transmit, to a first UE, a PSSCH on one or more interlaces of a carrier in a slot of a plurality of slots, wherein the carrier includes a plurality of interlaces and the plurality of slots correspond to the same PSFCH occasion; and a processor coupled to the transceiver and configured to: determine a PSFCH resource for receiving HARQ-ACK feedback for the PSSCH, wherein the PSFCH resource is on a first RB within an RB set of the carrier; and wherein the transceiver is further configured to receive, from the first UE, a signal on one or more RBs of a first plurality of RBs and the HARQ-ACK feedback on the PSFCH resource in the PSFCH occasion, wherein the first plurality of RBs is included in the RB set and has a frequency spanning exceeding a predefined percentage of a bandwidth of the RB set.

In some embodiments of the present disclosure, the first interlace within the RB set comprises the first plurality of RBs and a second plurality of RBs, and the second plurality of RBs is used for carrying HARQ-ACK feedback for a PSSCH(s).

In some embodiments of the present disclosure, the first RB is included in the second plurality of RBs and is determined based on an index of the slot within the plurality of slots and a mapping relationship between the plurality of slots and the second plurality of RBs.

In some embodiments of the present disclosure, the first RB is included in the second plurality of RBs and the PSFCH resource is determined based on at least one of: an index of the slot; the number of slots included in the plurality of slots; the number of RBs included in the second plurality of RBs; the number of cyclic shift pairs associated with the second plurality of RBs; a physical layer source identity (ID) associated with the PSSCH; a member ID of the first UE in a UE group comprising the first UE and the second UE.

In some embodiments of the present disclosure, the first interlace is a predefined interlace of the one or more interlaces.

In some embodiments of the present disclosure, the first plurality of RBs includes at least two RBs, and the second plurality of RBs includes the remaining RBs in the RB set.

In some embodiments of the present disclosure, the first plurality of RBs and the second plurality of RBs are spaced by a number of contiguous RBs.

In some embodiments of the present disclosure, the first plurality of RBs includes a first subset of RBs and a second subset of RBs located in two edges of the RB set, wherein the one or more RBs includes at least one RB selected from the first subset of RBs and at least one RB selected from the second subset of RBs.

In some embodiments of the present disclosure, the first RB is included in the second plurality of RBs and the PSFCH resource is determined based on at least one of: an index of the slot; the number of slots included in the plurality of slots; an index of an interlace of the one or more interlaces; the number of interlaces included in the plurality of interlaces; the number of RBs included in the second plurality of RBs; the number of cyclic shift pairs associated with the second plurality of RBs; a physical layer source ID associated with the PSSCH; or a member ID of the first UE in a UE group comprising the first UE and the second UE.

In some embodiments of the present disclosure, the first plurality of RBs is shared among one or more UEs including the first UE for transmitting respective HARQ-ACK feedback for a PSSCH(s) in the PSFCH occasion.

In some embodiments of the present disclosure, the first plurality of RBs is configured by RRC signaling or predefined.

Some embodiments of the present disclosure provide a method performed by a first UE. The method may include: receiving, from a second UE, a PSSCH on one or more interlaces of a carrier in a slot of a plurality of slots, wherein the carrier includes a plurality of interlaces and the plurality of slots correspond to the same PSFCH occasion; determining a PSFCH resource for transmitting HARQ-ACK feedback for the PSSCH, wherein the PSFCH resource is on a first RB within an RB set of the carrier; and transmitting, to the second UE, a signal on one or more RBs of a first plurality of RBs and the HARQ-ACK feedback on the PSFCH resource in the PSFCH occasion, wherein the first plurality of RBs is included in the RB set and has a frequency spanning exceeding a predefined percentage of a bandwidth of the RB set.

Some embodiments of the present disclosure provide a method performed by a second UE. The method may include: transmitting to a first UE, a PSSCH on one or more interlaces of a carrier in a slot of a plurality of slots, wherein the carrier includes a plurality of interlaces and the plurality of slots correspond to the same PSFCH occasion; determining a PSFCH resource for receiving HARQ-ACK feedback for the PSSCH, wherein the PSFCH resource is on a first RB within an RB set of the carrier; and receiving, from the first UE, a signal on one or more RBs of a first plurality of RBs and the HARQ-ACK feedback on the PSFCH resource in the PSFCH occasion, wherein the first plurality of RBs is included in the RB set and has a frequency spanning exceeding a predefined percentage of a bandwidth of the RB set.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates an example of an interlace-based resource block configuration according to some embodiments of the present disclosure;

FIGS. 3a and 3b illustrate exemplary partial interlace structures for 15 kHz subcarrier spacing (SCS) according to some embodiments of the present disclosure;

FIGS. 4a and 4b illustrate exemplary partial interlace structures for 30 kHz SCS according to some embodiments of the present disclosure;

FIG. 5 illustrates an exemplary mapping relationship between a plurality of slots and a plurality of RBs according to some embodiments of the present disclosure;

FIGS. 6a-6c illustrate exemplary partial interlace structures for 15 kHz SCS according to some embodiments of the present disclosure;

FIG. 7 illustrates a flow chart of an exemplary method for PSFCH transmission according to some embodiments of the present disclosure; and

FIG. 8 illustrates a simplified block diagram of an exemplary apparatus according to some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

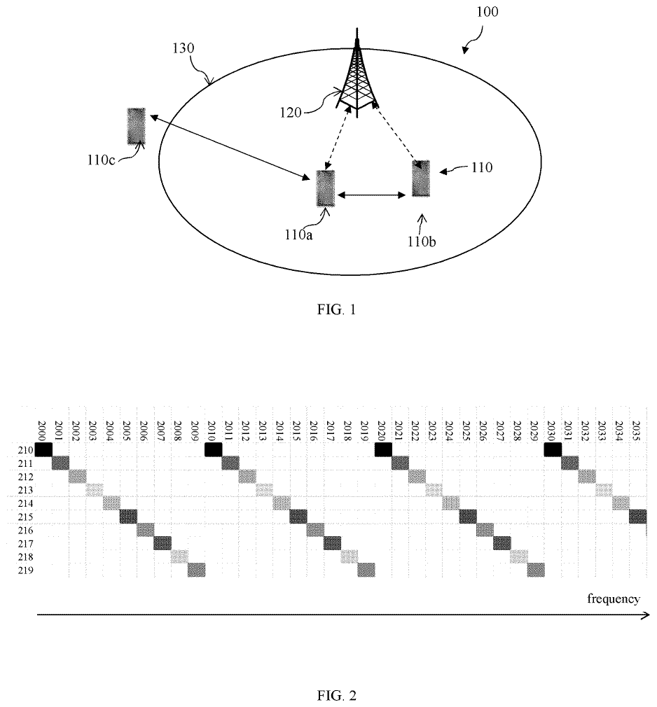

FIG. 1 illustrates a schematic diagram of a wireless communication system 100 in accordance with some embodiments of the present disclosure.

As shown in FIG. 1, wireless communication system 100 may include a base station (e.g., BS 120) and some UEs 110 (e.g., UE 110a, UE 110b, and UE 110c). Although a specific number of UEs 110 and one BS 120 are depicted in FIG. 1, it is contemplated that any number of BSs and UEs in and outside of the coverage of the BSs may be included in the wireless communication system 100.

In some embodiments of the present disclosure, BS 120 may be referred to as an access point, an access terminal, a base, a base unit, a macro cell, a Node-B, an evolved Node B (eNB), a gNB, a Home Node-B, a relay node, or a device, or described using other terminology used in the art. BS 120 is generally a part of a radio access network that may include one or more controllers communicably coupled to one or more corresponding BSs. BS 120 may communicate with UE(s) 110 via downlink (DL) communication signals.

UE(s) 110 (e.g., UE 110a, UE 110b, or UE 110c) may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, UE(s) 110 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, UE(s) 110 includes wearable devices, such as smart watches, fitness bands, optical head-mounted displays, or the like. Moreover, UE(s) 110 may be referred to as a subscriber unit, a mobile, a mobile station, a user, a terminal, a mobile terminal, a wireless terminal, a fixed terminal, a subscriber station, a user terminal, an IoT device, a vehicle, or a device, or described using other terminology used in the art. UE(s) 110 may communicate with BS 120 via uplink (UL) communication signals.

Wireless communication system 100 may be compatible with any type of network that is capable of sending and receiving wireless communication signals. For example, wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, wireless communication system 100 is compatible with 5G NR of the 3GPP protocol. For example, BS 120 may transmit data using an orthogonal frequency division multiple (OFDM) modulation scheme on the DL and UE(s) 110 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS 120 and UE(s) 110 may communicate using other communication protocols, such as the IEEE 802.11 family of wireless communication protocols. Further, in some embodiments of the present disclosure, BS 120 and UE(s) 110 may communicate over licensed spectrums, whereas in some other embodiments, BS 120 and UE(s) 110 may communicate over unlicensed spectrums. The present disclosure is not intended to be limited to the implementation of any particular wireless communication system architecture or protocol.

BS 120 may define one or more cells, and each cell may have a coverage area 130. In the exemplary wireless communication system 100, some UEs (e.g., UE 110a and UE 110b) are within the coverage of BS 120, which may not be the specific BS 120 as shown in FIG. 1 and can be any one of the BSs 120 in a wireless communication system, and some UEs (e.g., UE 110c) are outside of the coverage of BS 120. For example, in the case that the wireless communication system includes two BSs 120 with UE 110a being within the coverage of any one of the two BSs means that UE 110a is within the coverage of a BS 120 (i.e., in-coverage) in the wireless communication system; and UE 110a being outside of the coverage of both BSs 120 means that UE 110a is outside the coverage of a BS 120 (i.e., out-of-coverage) in the wireless communication system.

Still referring to FIG. 1, UE 110a and UE 110b may communicate with BS 120 via, for example, a Uu link (denoted by dotted arrow in FIG. 1). UE 110a, UE 110b, and UE 110c may communicate with each other via a sidelink (denoted by solid arrow in FIG. 1). In some embodiments, UE 110a, UE 110b, and UE 110c may form a UE group.

Sidelink transmission may involve a physical sidelink control channel (PSCCH) and an associated PSSCH, which is scheduled by the sidelink control information (SCI) carried on the PSCCH. The SCI and associated PSSCH may be transmitted from a transmitting UE (hereinafter referred to as “Tx UE”) to a receiving UE (hereinafter referred to as “Rx UE”) in a unicast manner, to a group of Rx UEs in a groupcast manner, or to Rx UEs within a range in a broadcast manner. For example, referring to FIG. 1, UE 110a (acting as a Tx UE) may transmit data to UE 110b or UE 110c (acting as an Rx UE).

The PSSCH may carry data which may require corresponding HARQ-ACK feedback (e.g., acknowledgment (ACK) or non-acknowledgment (NACK)) from the Rx UE(s) to the Tx UE. The HARQ-ACK feedback for a PSSCH may be carried on a PSFCH.

In some embodiments of the present disclosure, sidelink transmission may be performed on an unlicensed spectrum. For a sidelink transmission over an unlicensed spectrum, an interlace-based structure can be adopted for the sidelink channels including, for example, PSCCH, PSSCH and PSFCH, to obey the regulatory requirements. The requirements may include at least one of the following:
occupied channel bandwidth (OCB): the bandwidth containing 99% of the power of the signal, shall be between, for example, 80% and 100% of the declared nominal channel bandwidth; or
maximum power spectrum density (PSD) with a resolution bandwidth of, for example, 1 MHz (e.g., 10 dBm/MHz).

An interlace may be defined as a set of resource blocks (RBs) equally spaced in the frequency domain. For example, multiple interlaces of RBs may be defined in common RBs based on the SCS. The total number of interlaces in the frequency domain may be dependent on only the SCS of a carrier, regardless of concrete carrier bandwidth. For example, for 15 kHz SCS, there may be 10 interlaces on the carrier; and for 30 kHz SCS, there may be 5 interlaces on the carrier.

The number of RBs of each interlace may be dependent on the concrete carrier bandwidth. For example, for a 20 MHz bandwidth with 15 kHz SCS, each of the 10 interlaces may include 10 or 11 RBs; and for a 20 MHz bandwidth with 30 kHz SCS, each of the 5 interlaces may include 10 or 11 RBs. For a carrier bandwidth larger than 20 MHz, the same spacing between consecutive RBs in an interlace may be maintained for all interlaces regardless of the carrier bandwidth. That is, the number of RBs per interlace may be dependent on the carrier bandwidth. Keeping the same interlace spacing with increasing bandwidth is a straightforward and simple way to scale the interlace design from 20 MHz to a wider bandwidth(s). For example, for an 80 MHz bandwidth with 30 kHz SCS, each of the 5 interlaces may include 43 or 44 RBs.

FIG. 2 illustrates an example of interlace-based resource block configuration 200 for 15 kHz SCS according to some embodiments of the present disclosure. It should be understood that configuration 200 is only for illustrative purposes, and should not be construed as limiting the embodiments of the present disclosure.

As shown in FIG. 2, carrier bandwidth may be partitioned into resource blocks (RBs). For illustrative purposes, FIG. 2 only shows a part of the RBs (e.g., RBs that are represented with reference numerals 2000 to 2035 in FIG. 2) included in the carrier bandwidth. Persons skilled in the art can readily know the number of RBs included in a certain carrier bandwidth by referring to bandwidth configurations for different SCSs.

As mentioned above, the number of interlaces distributed within the bandwidth of a carrier may be based on only the SCS regardless of the bandwidth of the carrier. In the example of FIG. 2, the RBs of the carrier bandwidth are partitioned into 10 interlaces (corresponding to 15 kHz SCS), which are represented with reference numerals 210, 211, 212, 213, 214, 215, 216, 217, 218, and 219 in FIG. 2.

Each interlace of the 10 interlaces may include evenly-spaced RBs in the frequency domain. The number of RBs included in each of the 10 interlaces may depend on carrier bandwidth. As shown in FIG. 2, interlace 210 may include RB 2000, RB 2010, RB 2020, RB 2030, and so on; interlace 211 may include RB 2001, RB 2011, RB 2021, RB 2031, and so on; and interlace 219 may include RB 2009, RB 2019, RB 2029, and so on. RB 2000 to RB 2035 may be indexed from “0” to “35” along the frequency axis, and interlaces 210 to 219 may be indexed from “0” to “9”.

The concept of “RB set” is specified in Rel-16 5G NR in unlicensed spectrum (NR-U), which defines the exact available RBs without RBs in either inter-cell guard band or intra-cell guard band. The guard band and RB set are configured by RRC signaling in unit of common resource block (CRB). In detail, when the UE is configured with intraCellGuardBand for a carrier, the UE is provided with N_{RB-set}−1 intra-cell guard bands on the carrier, each defined by a start CRB and an end CRB,

$$G {B}_{s}^{start , μ} and {GB}_{s}^{end , μ} ,$$

respectively. The intra-cell guard bands separate N_{RB-set} RB sets, each defined by a start CRB and an end CRB,

$$R {B}_{s}^{start , μ} and {RB}_{s}^{end , μ} ,$$

respectively. The UE determines

$${RB}_{0}^{start , μ} = {N}_{g r i d}^{start , μ} , R {B}_{{N}_{R B - set} - 1}^{end , μ} = {N}_{g r i d}^{start , μ} + {N}_{g r i d}^{size , μ} ,$$

and the remaining end and start CRBs as

$$R {B}_{s}^{end , μ} = {GB}_{s}^{start , μ} - 1 and {RB}_{s + 1}^{start , μ} = G {B}_{s}^{end , μ} + 1 .$$

+1. When the UE is not configured with intraCellGuardBand, the UE determines intra-cell guard band and corresponding RB set according to the default intra-cell guard band pattern from TS38.101 corresponding to u and carrier size

$${N}_{grid}^{size , μ} .$$

The specific definitions of the variables or parameters as mentioned above can be found in 3GPP standard documents.

As stated above, for a sidelink transmission over an unlicensed spectrum, the interlace-based structure can be adopted for sidelink channels. For example, for a given PSSCH transmission on one or multiple interlaces for unicast purposes, one interlace may be enough for the Rx UE to transmit the corresponding PSFCH. For example, for a given PSSCH transmission for groupcast purposes, in the case of a first type of groupcast (also referred to as “groupcast option 1” or “groupcast NACK only based HARQ-ACK feedback”) being enabled, all the Rx UEs may share one PSFCH resource, and an Rx UE may transmit a negative ACK (NACK) on the PSFCH resource if it does not correctly decode the PSSCH or transmit nothing on the PSFCH resource if it correctly decodes the PSSCH. In this scenario, one interlace would be enough for a group of UEs to transmit corresponding PSFCHs on the same PSFCH resource. In the case of a second type of groupcast (also referred to as “groupcast option 2” or “groupcast ACK or NACK based HARQ-ACK feedback”) being enabled, each of the Rx UEs may have a separate PSFCH resource, and an Rx UE may transmit a NACK on the PSFCH resource if it does not correctly decode the PSSCH, or transmit ACK on the PSFCH resource if it correctly decodes the PSSCH. In this scenario, multiple interlaces may be needed so that each Rx UE can transmit a corresponding PSFCH.

When the interlace-based structure is employed for sidelink transmissions, the unit of the PSFCH resource is an interlace, instead of a RB. However, the number of PSFCH resources is quite limited and dependent on the number of interlaces. For example, for 15 kHz SCS, there may be 10 interlaces; and for 30 kHz SCS, there may be 5 interlaces. Hence, it is desirable to improve PSFCH resource capacity. Moreover, a PSFCH resource mapping procedure is needed for a UE to determine a PSFCH resource and avoid potential PSFCH resource collision.

Embodiments of the present disclosure propose solutions for PSFCH transmission over an unlicensed spectrum. For example, embodiments of the present disclosure propose solutions for determining a PSFCH resource and solutions regarding how to transmit and receive HARQ-ACK feedback on the PSFCH resource. The solutions in the embodiments of the present disclosure can improve the PSFCH capacity and avoid potential PSFCH resource collision. More details on embodiments of the present disclosure will be described in the following text in combination with the appended drawings.

According to some embodiments of the present disclosure, a Tx UE may transmit one or more PSSCHs over an unlicensed spectrum to an Rx UE (e.g., via a unicast manner, a groupcast manner, etc.). Each PSSCH may be transmitted on one or more interlaces of a carrier and in a slot of a plurality of slot corresponding to the same PSFCH occasion. Consequently, the Rx UE may receive the one or more PSSCHs. Then, the Rx UE may transmit HARQ-ACK feedback for the one or more PSSCHs on a PSFCH in the PSFCH occasion. In the embodiments of the present disclosure, a partial interlace structure is proposed for transmitting PSFCH carrying HARQ-ACK feedback for the one or more PSSCHs. The following embodiments may provide various partial interlace structures for transmitting the HARQ-ACK feedback.

### Embodiment 1

In Embodiment 1, the partial interlace structure is based on an interlace (also referred to as a full interlace) of a carrier and includes a subset of interlaced RBs of the interlace. When the partial interlace is used for transmitting a PSFCH(s) carrying HARQ-ACK feedback for corresponding PSSCH(s), the partial interlace may be confined within an RB set. The RB set may be determined based on the concept as stated above.

For example, the carrier may include a plurality of interlaces, each interlace within the RB set may include a first plurality of RBs and a second plurality of RBs. The first plurality of RBs may also be referred to as a first set of RBs, and the second plurality of RBs may also be referred to as a second set of RBs.

The first plurality of RBs of each interlace is not used for transmitting HARQ-ACK feedback for PSSCH(s). The first plurality of RBs of each interlace is only used for meeting the OCB requirements. In some embodiments, the first plurality of RBs has a frequency spanning exceeding a predefined percentage (e.g., 80%) of a bandwidth of the RB set. For example, the first plurality of RBs may include at least two RBs (e.g., the first RB and the last RB) of an interlace such that an OCB requirement can be met (e.g., exceeding a predefined percentage of a bandwidth of the RB set). The second plurality of RBs of each interlace may be used for transmitting HARQ-ACK feedback for the PSSCH(s).

When transmitting the PSFCH based on the partial interlace structure for one or more PSSCHs, one or more RBs may be determined from the second plurality of RBs of an interlace for transmitting the HARQ-ACK feedback for the one or more PSSCHs. The one or more RBs from the second plurality of RBs and the first plurality of RBs of the interlace may be combined and regarded as one partial interlace. Since some RBs within the second plurality of RBs are not used for transmitting the PSFCH, in other words, only a subset of RBs within the interlace is used for transmitting the PSFCH, such mechanism is referred to as a partial interlace structure for Embodiment 1.

Accordingly, the interlace within an RB set of a carrier may correspond to (or be associated with) multiple partial interlaces. For multiple partial interlaces associated with the same interlace, the first plurality of RBs may be common or shared among the multiple partial interlaces. For example, assuming that there are N RBs in the second plurality of RBs of the interlace, then the interlace may correspond to at most N partial interlaces, where each of the N partial interlaces shares the same first plurality of RBs and includes different RBs in the second plurality of RBs. Each partial interlace may be used to transmit a PSFCH. Consequently, the interlace may correspond to at most N PSFCHs based on the partial interlace structure, and thus the PSFCH capacity is greatly increased. In this way, the partial interlace structure not only can meet the OCB requirements, but also can transmit HARQ-ACK feedback with significantly less RBs (e.g., using one RB to transmit one HACK-ACK information bit) compared with using a full interlace for transmitting one HACK-ACK information bit.

As stated above, the first plurality of RBs is not used for transmitting HARQ-ACK feedback for a PSSCH(s). When a partial interlace is used for transmitting HARQ-ACK feedback, the Rx UE (e.g., the PSFCH transmitting UE) may arbitrarily transmit a signal (e.g., ACK, NACK, or any dummy bits) on the first plurality of RBs, and transmit HARQ-ACK feedback on the determined one or more RBs of the second plurality of RBs for a PSSCH(s) via a (e.g., predetermined) PSFCH format (e.g., PSFCH format 0 as specified in 3GPP standard documents). The Tx UE (e.g., the PSFCH receiving UE) may skip the detection on the first plurality of RBs, and only detect the HARQ-ACK feedback on the one or more RBs of the second plurality of RBs.

In some embodiments of the present disclosure, the first plurality of RBs may be preconfigure or configured by RRC signaling from a BS. In some embodiments of the present disclosure, the first plurality of RBs may be predefined, e.g., in the 3GPP standard documents.

In some embodiments of the present disclosure, the second plurality of RBs may be preconfigure or configured by RRC signaling from a BS. In some embodiments of the present disclosure, the second plurality of RBs may be predefined, e.g., in the 3GPP standard documents. In some embodiments of the present disclosure, for an interlace within an RB set of a carrier, except for the first plurality of RBs within the interlace, all the remaining RBs may be included in the second plurality of RBs.

In some embodiments of the present disclosure, the partial interlace structure may be set to fulfil a principle that the number of RBs included in the second plurality of RBs of each interlace within an RB set of a carrier is the same (hereinafter referred to as principle #1). In some embodiments of the present disclosure, the partial interlace structure may be set to fulfil a principle that the number of RBs included in the first plurality of RBs of each interlace within an RB set of a carrier is the same (hereinafter referred to as principle #2).

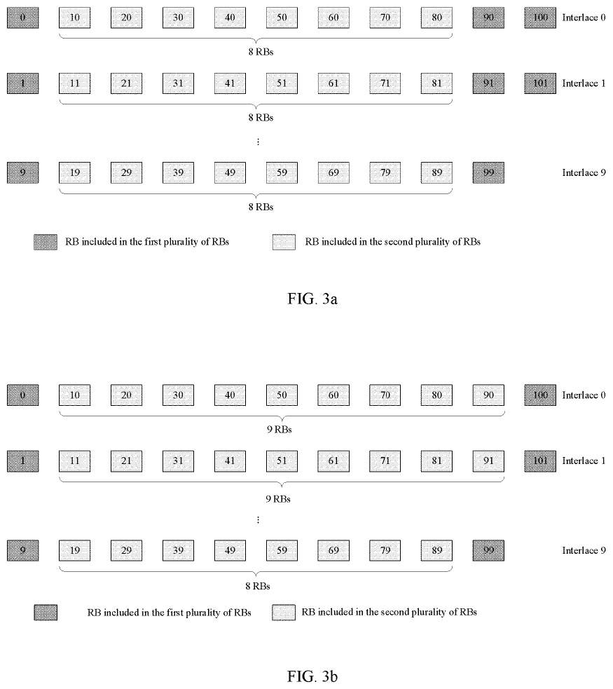

FIGS. 3a and 3b illustrate exemplary interlace structures for 15 kHz SCS according to some embodiments of the present disclosure.

In FIGS. 3a and 3b, it is assumed that the bandwidth of a carrier is 20 MHz, and the RB set of the carrier includes 106 RBs, e.g., denoted as RBs 0-105. For 15 kHz SCS, there are 10 interlaces (e.g., denoted as interlaces 0-9) in the carrier. Within the RB set, each of interlace 0 to interlace 5 includes 11 RBs, while each of interlace 6 to interlace 9 includes 10 RBs. For simplicity, only three interlaces, e.g., interlace 0, interlace 1, and interlace 9 and a part RB of the carrier are shown in FIGS. 3a and 3b.

Referring to FIG. 3a, it illustrates an exemplary interlace structure for 15 kHz SCS which fulfils principle #1. To meet the OCB requirements and principle #1, within an RB set, for each of interlace 0 to interlace 5, the first plurality of RBs includes 3 RBs, e.g., the first RB, the last RB, and the penultimate RB of the corresponding interlace, and for each of interlace 6 to interlace 9, the first plurality of RBs includes 2 RBs, e.g., the first RB and the last RB of the corresponding interlace. In this way, for each interlace of the carrier, the second plurality of RBs may include the same number of RBs, e.g., 8 RBs as shown in FIG. 3a.

Referring to FIG. 3b, it illustrates an exemplary interlace structure for 15 kHz SCS which fulfils principle #2. To meet the OCB requirements and principle #2, within an RB set, for each of interlace 0 to interlace 9, the first plurality of RBs includes 2 RBs, e.g., the first RB and the last RB of the corresponding interlace. For each of interlace 0 to interlace 5, the second plurality of RBs includes 9 RBs, e.g., from the second RB to the penultimate RB of the corresponding interlace, and for each of interlace 6 to interlace 9, the second plurality of RBs comprises 8 RBs, e.g., from the second RB to the penultimate RB of the corresponding interlace.

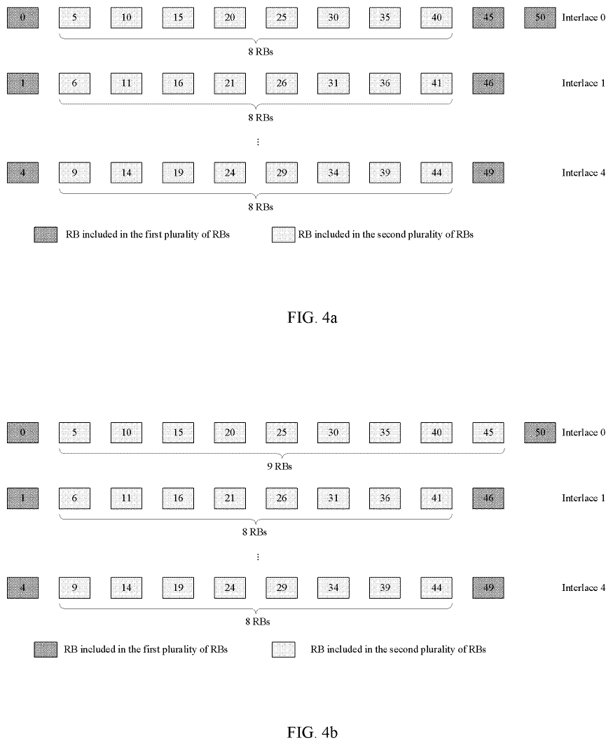

FIGS. 4a and 4b illustrate exemplary interlace structures for 30 kHz SCS according to some embodiments of the present disclosure.

In FIGS. 4a and 4b, it is assumed that a bandwidth of a carrier is 20 MHz, and the RB set of the carrier includes 51 RBs, e.g., denoted as RBs 0-50. For 30 kHz SCS, there are 5 interlaces (e.g., denoted as interlaces 0-4) in the carrier. Within the RB set, each of interlace 1 to interlace 4 includes 10 RBs, while interlace 0 includes 11 RBs. For simplicity, only three interlaces, e.g., interlace 0, interlace 1, and interlace 4 and a part RB of the carrier are shown in FIGS. 4a and 4b.

Referring to FIG. 4a, it illustrates an exemplary interlace structure for 30 kHz SCS which fulfils principle #1. To meet the OCB requirements and principle #1, within an RB set, for interlace 0, the first plurality of RBs includes 3 RBs, e.g., the first RB, the last RB, and the penultimate RB of interlace 0, and for each of interlace 1 to interlace 4, the first plurality of RBs includes 2 RBs, e.g., the first RB, and the last RB of the corresponding interlace. In this way, for each interlace of the carrier, the second plurality of RBs may include the same number of RBs, e.g., 8 RBs as shown in FIG. 4a.

Referring to FIG. 4b, it illustrates an exemplary interlace structure for 30 kHz SCS which fulfils principle #2. To meet the OCB requirements and principle #2, within an RB set, for each of interlace 0 to interlace 4, the first plurality of RBs includes 2 RBs, e.g., the first RB, and the last RB of the corresponding interlace. For interlace 0, the second plurality of RBs includes 9 RBs, e.g., from the second RB to the penultimate RB of the corresponding interlace, and for each of interlace 1 to interlace 4, the second plurality of RBs comprises 8 RBs, e.g., from the second RB to the penultimate RB of the corresponding interlace.

The above partial interlace structure may be used for determining one or more PSFCH resources for transmitting HARQ-ACK feedback for the one or more PSSCHs, wherein each PSSCH may be transmitted on one or more interlaces of a carrier and in a slot of a plurality of slots corresponding to the same PSFCH occasion. For example, for each PSSCH, the Tx UE and the Rx UE may determine a corresponding PSFCH resource for transmitting HARQ-ACK feedback for the PSSCH based on the above partial interlace structure.

For simplicity, the following embodiments take a PSSCH (e.g., PSSCH #A1, which is transmitted on one or more interlaces of a carrier and in a slot of the plurality of slots) of the one or more PSSCHs as an example to illustrate how to determine a PSFCH resource for transmitting HARQ-ACK feedback for the PSSCH. Such solutions may also apply to other PSSCHs of the one or more PSSCHs.

According to some embodiments of the present disclosure, a certain PSFCH format (e.g., PSFCH format 0) may be used for transmitting HARQ-ACK feedback for a PSSCH. The PSFCH resource for transmitting HARQ-ACK feedback for PSSCH #A1 may be on an RB (e.g., denoted as RB #B1) within an RB set of the carrier. In such embodiments, determining the PSFCH resource for transmitting HARQ-ACK feedback for PSSCH #A1 may include determining RB #B1 for transmitting HARQ-ACK feedback for PSSCH #A1. In some embodiments of the present disclosure, the cyclic shift pair may be applied for transmitting the HARQ-ACK feedback for PSSCH #A1 and may be configured by RRC signalling or may be selected by the UE.

In some embodiments, RB #B1 may be included in the second plurality of RBs of an interlace (e.g., denoted as interlace j) of the one or more interlaces on which PSSCH #A1 is transmitted and determined based on an index of the slot (e.g., denoted as slot i) in which PSSCH #A1 is transmitted and a mapping relationship between the plurality of slots and the second plurality of RBs.

In an embodiment, interlace j may be a predefined interlace of the one or more interlaces. For example, interlace j may be an interlace with the lowest or highest interlace index among the one or more interlaces on which PSSCH #A1 is transmitted. In another example, interlace j may be any other interlace among the one or more interlaces.

In an embodiment, the mapping relationship between the plurality of slots and the second plurality of RBs may define in a manner that each slot of the plurality of slots corresponds to an RB in the second plurality of RBs. For example, the mapping relationship may be a table indicating a correspondence between each slot of the plurality of slots and a corresponding RB in the second plurality of RBs. In another example, the mapping relationship may be defined as an equation, e.g., an offset is predefined between an index of a slot in the plurality of slots and an index of a corresponding RB in the second plurality of RBs. For example, the offset may be equal to 0, which means that a slot with an index “m” in the plurality of slots corresponds to an RB with the same index “m” in the second plurality of RBs. Accordingly, based on the index of slot (e.g., slot i) and the mapping relationship between the plurality of slots and the second plurality of RBs, the Rx UE and the Tx UE may determine RB #B1 in the second plurality of RBs for transmitting the HARQ-ACK feedback for PSSCH #A1.

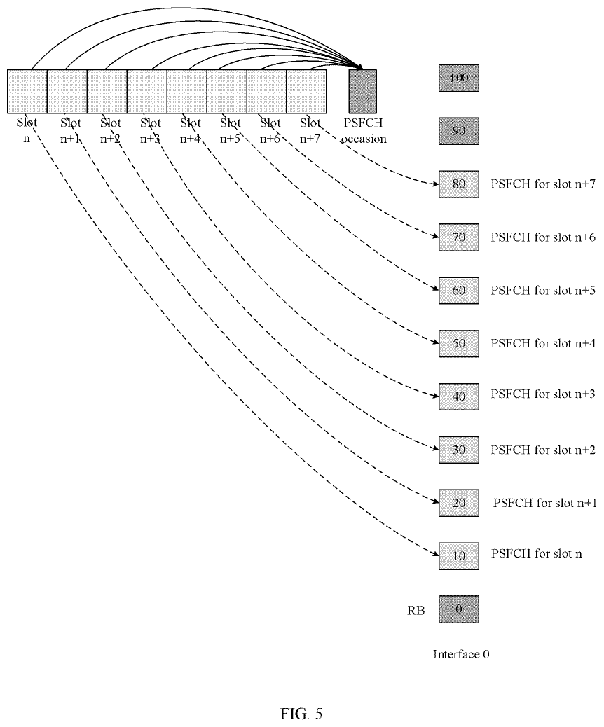

FIG. 5 illustrates an exemplary mapping relationship between a plurality of slots and the second plurality of RBs according to some embodiments of the present disclosure.

Referring to FIG. 5, within an RB set, it is assumed that the first RB, the penultimate RB and the last RB are included in the first plurality of RBs of interlace 0 while the other RBs are included in the second plurality of RBs of interlace 0. Accordingly, the first plurality of RBs of interlace 0 includes 3 RBs, i.e., RBs 0, 90, and 100, and the second plurality of RBs of interlace 0 includes 8 RBs, i.e., RBs 10, 20, . . . , and 80, which may be indexed from 0 to 7.

Moreover, it is assumed that the mapping relationship indicates that a slot with an index “m” in a plurality of slots corresponding to the same PSFCH transmission occasion corresponds to an RB with the same index “m” in the second plurality of RBs. For example, a slot with index 0 in the plurality of slots may correspond to RB 10 because the indexes are the same, e.g., both are “0.”

Assuming that a plurality of PSSCHs is transmitted on the same interlace (e.g., interlace 0) in the plurality of slots (e.g., slot n to slot n+7), which correspond to the same PSFCH transmission occasion. A UE may generate a corresponding PSFCH within an RB set for a PSSCH in a corresponding slot of slot n to slot n+7. In some examples, the UE may determine that the PSFCHs for the plurality of PSSCHs should be transmitted in interlace 0. Slot n to slot n+7 may be indexed from 0 to 7 among slot n to slot n+7.

Therefore, within the RB set, the PSFCH corresponds to the PSSCH on interlace 0 in slot n can be transmitted on RB 10 of interlace 0, the PSFCH corresponds to the PSSCH on interlace 0 in slot n+1 can be transmitted on RB 20 of interlace 0, the PSFCH corresponds to the PSSCH on interlace 0 in slot n+2 can be transmitted on RB 30 of interlace 0, . . . , the PSFCH corresponds to the PSSCH on interlace 0 in slot n+7 can be transmitted on RB 80 of interlace 0.

In some examples, in the case that an Rx UE receives 4 PSSCH (e.g., denoted as PSSCHs #0-#3) on interlace 0 on slots n to n+3, within the RB set, the Rx UE may transmit a signal (e.g., ACK, NACK, or any dummy bits) on RBs 0, 90, and 100 of interlace 0, and HARQ-ACK feedback for PSSCH #0 on RB 10 of interlace 0, HARQ-ACK feedback for PSSCH #1 on RB 20 of interlace 0, HARQ-ACK feedback for PSSCH #2 on RB 30 of interlace 0, and HARQ-ACK feedback for PSSCH #3 on RB 40 of interlace 0. The Tx UE may receive the HARQ-ACK feedback within the RB set from the Rx UE. For example, the Tx UE may skip the detection on RBs 0, 90, and 100 and only detect HARQ-ACK feedback on RBs 10, 20, 30, and 40.

According to some embodiments of the present disclosure, when a certain PSFCH format (e.g., PSFCH format 0) is used for transmitting HARQ-ACK feedback, the HARQ-ACK feedback for PSSCH #A1 may be transmitted on an RB (e.g., a single RB) of the RB set. The PSFCH resource for transmitting HARQ-ACK feedback for PSSCH #A1 may be determined based on at least one of:
an index of the slot in which pssch #A1 is transmitted;
the number of slots included in the plurality of slots;
the number of RBs included in the second plurality of RBs;
the number of cyclic shift pairs associated with the second plurality of RBs;
a physical layer source ID associated with PSSCH #A1. For example, a physical layer source ID associated with PSSCH #A1 may be a physical layer source ID of a Tx UE transmitting PSSCH #A1 and can be indicated in the SCI scheduling PSSCH #A1; or
a member ID of the Rx UE receiving PSSCH #A1 in a UE group comprising the Rx UE and the Tx UE transmitting PSSCH #A1. For example, the member ID may be indicated by higher layers if the SCI scheduling PSSCH #A1 indicates that the groupcast ACK or NACK based HARQ-ACK feedback is enabled (e.g., a value of a cast type indicator field of the SCI is “01”).

For example, the PSFCH resource for transmitting HARQ-ACK feedback for PSSCH #A1 may be determined based on the following formula:

$$( {P}_{ID} + {M}_{ID} + i ) mod {R}_{PRB , CS}^{PSFCH}$$

Wherein PID refers to the physical layer source ID; MID refers to the identity of the UE receiving PSSCH #A1 in a UE group in the case that groupcast ACK or NACK based HARQ-ACK feedback is enabled, or otherwise, MID is zero;

$${R}_{PRB , CS}^{PSFCH} = ( the number of RBs included in the second plurality of RBs ) * ( the number of cyclic shift pairs associated with the second \\ plurality of RBs ) ,$$

i is the index of the slot in which PSSCH #A1 is transmitted. The number of slots included in the plurality of slots determines the value range of i.

Based on the above embodiments, the Tx UE and the Rx UE may determine one or more PSFCH resources within the second plurality of RBs of an interlace for transmitting HARQ-ACK feedback for the one or more PSSCHs, wherein each PSFCH resource of the one or more PSFCH resources may be used for transmitting HARQ-ACK feedback for a corresponding PSSCH of the one or more PSSCHs.

Then, the Rx UE may transmit, to the Tx UE, a signal (e.g., ACK, NACK, or any dummy bits) on the first plurality of RBs of the interlace, and the HARQ-ACK feedback on the one or more PSFCH resources in the PSFCH occasion.

The Tx UE may receive the HARQ-ACK feedback on the one or more PSFCH resources in the PSFCH occasion. In some examples, the Tx UE may skip the detection on the first plurality of RBs and only detect the HARQ-ACK feedback on the one or more PSFCH resources. Embodiment 2

In Embodiment 2, the partial interlace structure is based on an RB set of a carrier and includes a subset of RBs of the RB set. The RB set may be determined based on the concept as stated above.

For example, the carrier may include at least one RB set. The RB set may include a first plurality of RBs and a second plurality of RBs. The first plurality of RBs may also be referred to as a first set of RBs, and the second plurality of RBs may also be referred to as a second set of RBs.

The first plurality of RBs is not used for transmitting HARQ-ACK feedback for PSSCH(s). The first plurality of RBs is only used for meeting the OCB requirements. In some embodiments, the first plurality of RBs has a frequency spanning exceeding a predefined percentage (e.g., 80%) of a bandwidth of the RB set. For example, the first plurality of RBs may include at least two RBs with frequency satisfying the OCB requirement (e.g., spanning a predefined percentage of a bandwidth of the RB set). The second plurality of RBs may be used for transmitting HARQ-ACK feedback for the PSSCH(s).

When transmitting the PSFCH based on the partial interlace structure for one or more PSSCHs, one or more RBs may be determined from the second plurality of RBs for transmitting the HARQ-ACK feedback for the one or more PSSCHs. The one or more RBs from the second plurality of RBs and the first plurality of RBs may be combined and regarded as one partial interlace. Since some RBs within the second plurality of RBs are not used for transmitting the PSFCH, in other words, only a subset of the RB set is used for transmitting the PSFCH, such mechanism is referred to as a partial interlace structure for Embodiment 2.

Accordingly, the RB set may correspond to (or be associated with) multiple partial interlaces. For multiple partial interlaces associated with the same RB set, the first set of RBs may be common or shared to the multiple partial interlaces.

For example, assuming that there are N RBs in the second plurality of RBs, then the RB set may correspond to at most N partial interlaces, where each of the N partial interlaces shares the same first plurality of RBs and includes different RBs in the second plurality of RBs. Each partial interlace may be used to transmit a PSFCH. Consequently, the RB set may correspond to at most N PSFCHs based on the partial interlace structure, and thus the PSFCH capacity is greatly increased. In this way, the partial interlace structure not only can meet the OCB requirements but also can transmit HARQ-ACK feedback with significantly less RBs (e.g., using one RB to transmit one HACK-ACK information bit) compared with using a full interlace for transmitting one HACK-ACK information bit.

As stated above, the first plurality of RBs is not used for transmitting HARQ-ACK feedback for a PSSCH(s). When a partial interlace is used for transmitting HARQ-ACK feedback, the Rx UE (e.g., the PSFCH transmitting UE) may arbitrarily transmit a signal (e.g., ACK, NACK, or any dummy bits) on the first plurality of RBs, and transmit HARQ-ACK feedback on the determined one or more RBs of the second plurality of RBs for a PSSCH(s) via a (e.g., predetermined) PSFCH format (e.g., PSFCH format 0 as specified in 3GPP standard documents). The Tx UE (e.g., the PSFCH receiving UE) may skip the detection on the first plurality of RBs, and only detect the HARQ-ACK feedback on the one or more RBs of the second plurality of RBs.

In some embodiments of the present disclosure, the first plurality of RBs may be preconfigure or configured by RRC signaling from a BS. In some embodiments of the present disclosure, the first plurality of RBs may be predefined, e.g., in the 3GPP standard documents.

In some embodiments of the present disclosure, the second plurality of RBs may be preconfigure or configured by RRC signaling from a BS. In some embodiments of the present disclosure, the second plurality of RBs may be predefined, e.g., in the 3GPP standard documents. In some embodiments of the present disclosure, except for the first plurality of RBs within the RB set, all the remaining RBs in the RB set may be included in the second plurality of RBs.

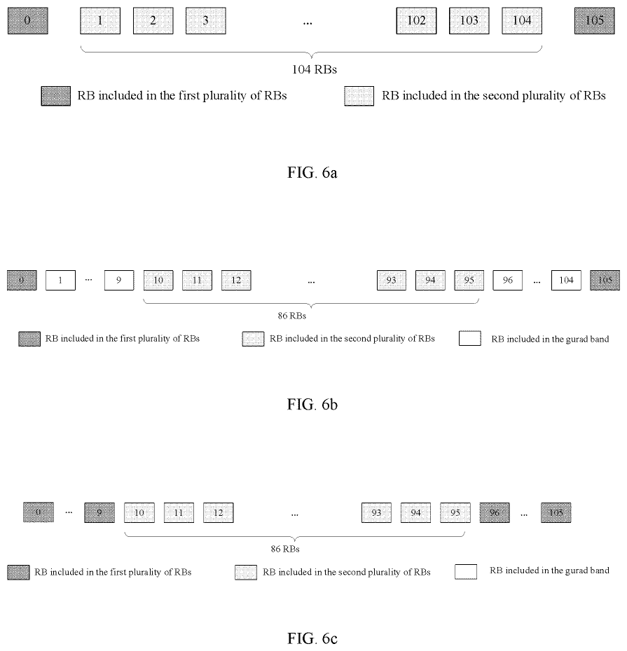

In some embodiments of the present disclosure, the partial interlace structure may be set such that the second plurality of RBs includes a maximum number of RBs in the RB set other than the first plurality of RBs that allows the first plurality of RBs satisfying the predefined percentage (e.g., denoted as principle #1′). For example, the first plurality of RBs may include 2 RBs, and the second plurality of RBs may include remaining RBs in the RB set. An exemplary partial interlace structure is shown in FIG. 6a.

In some embodiments of the present disclosure, the partial interlace structure may be set such that there is a certain guard band between an edge RB in the first plurality of RBs and an edge RB in the second plurality of RBs so as to mitigate the in-band emission effect and meet the PSD requirement (e.g., 10 dBm per MHz bandwidth) (e.g., denoted as principle #2′). For example, the first plurality of RBs and the second plurality of RBs are spaced by a number of contiguous RBs. The number of contiguous RBs may serve as the guard band as stated above. In an embodiment, the number of contiguous RBs is configured by an RRC signaling. In another embodiment, the number of contiguous RBs is predefined (e.g., in the 3GPP standard documents). An exemplary partial interlace structure is shown in FIG. 6b.

In some embodiments of the present disclosure, the first plurality of RBs includes a first subset of RBs and a second subset of RBs located in two edges of the RB set, and each subset may include one or more RBs including guard RBs (e.g., denoted as principle #3′). When transmitting the PSFCH, the Rx UE may select (e.g., randomly select) at least one RB within each subset (e.g., randomly selects one RB from the first subset and another RB from the second subset), and transmit a signal (e.g., ACK, NACK, or any dummy bits) on the selected at least one RB. An exemplary partial interlace structure is shown in FIG. 6c.

FIGS. 6a-6c illustrate exemplary partial interlace structures for 15 kHz SCS according to some embodiments of the present disclosure.

In FIGS. 6a-6c, it is assumed that a bandwidth of a carrier is 20 MHz, and the RB set of the carrier includes 106 RBs, e.g., denoted as RBs 0-105. For simplicity, only a part of RBs 0-105 are shown in FIGS. 6a-6c.

Referring to FIG. 6a, it illustrates an exemplary partial interlace structure for 15 kHz SCS which fulfils principle #1′. To meet the OCB requirements and principle #1′, the first plurality of RBs may include two 2 RBs, e.g., the first RB and the last RB of the RB set, and the second plurality of RBs may include 104 RBs. Accordingly, a maximum number of 104 partial interlaces may be used for transmitting PSFCH, so as to support maximum 104 PSFCH transmissions in one PSFCH occasion.

Referring to FIG. 6b, it illustrates an exemplary partial interlace structure for 15 kHz SCS which fulfils principle #2′. To meet the OCB requirements and principle #2′, it is assumed that the first plurality of RBs may include two 2 RBs, e.g., the first RB and the last RB of the RB set, and the first plurality of RBs and the second plurality of RBs are spaced by 9 contiguous RBs. Accordingly, the second plurality of RBs may include 86 RBs. Thus, a maximum number of 86 partial interlaces may be used for transmitting PSFCH, so as to support maximum 86 PSFCH transmissions in one PSFCH occasion.

Referring to FIG. 6c, it illustrates an exemplary partial interlace structure for 15 kHz SCS which fulfils principle #3′. To meet the OCB requirements and principle #3′, it is assumed that the first plurality of RBs includes a first subset of RBs and a second subset of RBs, each subset of RBs includes 10 RBs. Accordingly, the second plurality of RBs may include 86 RBs. Thus, a maximum number of 86 partial interlaces may be used for transmitting PSFCH, so as to support maximum 86 PSFCH transmissions in one PSFCH occasion.

FIGS. 6a-6c illustrate exemplary partial interlace structures for 15 kHz SCS. For a carrier with 20 MHz bandwidth and 30 kHz SCS, there are 51 RBs within the RB set. To meet the OCB requirements and principles #1′-3′, various partial interlace structures similar to the partial interlace structures for 15 kHz SCS may also be determined and are omitted herein.

The above partial interlace structure may be used for determining one or more PSFCH resources for transmitting HARQ-ACK feedback for the one or more PSSCHs, wherein each PSSCH may be transmitted on one or more interlaces of a carrier and in a slot of a plurality of slots corresponding to the same PSFCH occasion.

For example, for each PSSCH, the Tx UE and the Rx UE may determine a corresponding PSFCH resource for transmitting HARQ-ACK feedback for the PSSCH based on the above partial interlace structure. For simplicity, the following embodiments take a PSSCH (e.g., PSSCH #A2, which is transmitted on one or more interlaces of a carrier and in a slot of the plurality of slots) of the one or more PSSCHs as an example to illustrate how to determine a PSFCH resource for transmitting HARQ-ACK feedback for the PSSCH. Such solutions may also apply to other PSSCHs of the one or more PSSCHs.

According to some embodiments of the present disclosure, a certain PSFCH format (e.g., PSFCH format 0) is used for transmitting HARQ-ACK feedback. The HARQ-ACK feedback for PSSCH #A2 is transmitted on an RB (e.g., a single RB) of the RB set. The PSFCH resource for transmitting HARQ-ACK feedback for PSSCH #A2 may be determined based on at least one of:
an index of the slot (e.g., denoted as i) in which PSSCH #A2 is transmitted;
the number of slots (e.g., denoted as N) included in the plurality of slots;
an index of an interlace (e.g., denoted as j) of the one or more interlaces on which PSSCH #A2 is transmitted. In some embodiments, the interlace j may be a predefined interlace of the one or more interlaces. For example, interlace j may be an interlace with the lowest or highest interlace index among the one or more interlaces on which PSSCH #A2 is transmitted. In another example, interlace j may be any other interlace among the one or more interlaces.
the number of interlaces (e.g., denoted as M) included in the plurality of interlaces of the carrier;
the number of RBs included in the second plurality of RBs;
the number of cyclic shift pairs associated with the second plurality of RBs;
a physical layer source ID associated with PSSCH #A2. For example, a physical layer source ID associated with PSSCH #A2 may be a physical layer source ID of a Tx UE transmitting PSSCH #A2 and can be indicated in the SCI scheduling PSSCH #A2;
a member ID of the Rx UE receiving PSSCH #A2 in a UE group comprising the Rx UE and the Tx UE transmitting PSSCH #A2. For example, the member ID may be indicated by higher layers if the SCI scheduling PSSCH #A2 indicates that the groupcast ACK or NACK based HARQ-ACK feedback is enabled (e.g., a value of a cast type indicator field of the SCI is “01”).

For example, the PSFCH resource for transmitting HARQ-ACK feedback for PSSCH #A2 may be determined based on the following formula:

$$( {P}_{ID} + {M}_{ID} + i * M + j ) mod {R}_{PRB , CS}^{PSFCH}$$

In another example, the PSFCH resource for transmitting HARQ-ACK feedback for PSSCH #A2 may be determined based on the following formula:

$$( {P}_{ID} + {M}_{ID} + j * N + i ) mod {R}_{P RB , CS}^{PSFCH}$$

In the above examples, wherein P_{ID} refers to the physical layer source ID; M_{ID} refers to the identity of the UE receiving PSSCH #A2 in a UE group in the case that groupcast ACK or NACK based HARQ-ACK feedback is enabled, or otherwise, M_{ID} is zero;

$${R}_{PRB , CS}^{PSFCH} = ( the number of RBs included in the second plurality of RBs ) * ( the number of cyclic shift pairs associated with the second plurality of RBs ) ;$$

N refers to the number of slots included in the plurality of slots; M refers to the number of interlaces included in the plurality of interlaces; i refers to the index of the slot in which PSSCH #A2 is transmitted, wherein the number of slots included in the plurality of slots determines the value range of i (e.g., 0≤i≤N−1); and j refers to the index of the interlace as stated above, wherein the number of interlaces included in the plurality of interlaces determines the value range of j (e.g., 0<j≤M−1).

Based on the above embodiments, the Tx UE and the Rx UE may determine one or more PSFCH resources within the second plurality of RBs for transmitting HARQ-ACK feedback for the one or more PSSCHs.

Then, the Rx UE may transmit, to the Tx UE, a signal (e.g., ACK, NACK, or any dummy bits) on one or more RBs of the first plurality of RBs of the interlace, and the HARQ-ACK feedback on the one or more PSFCH resources in the PSFCH occasion.

The Tx UE may receive the HARQ-ACK feedback on the one or more PSFCH resources in the PSFCH occasion. In some examples, the Tx UE may skip the detection on the first plurality of RBs and only detect the HARQ-ACK feedback on the one or more PSFCH resources.

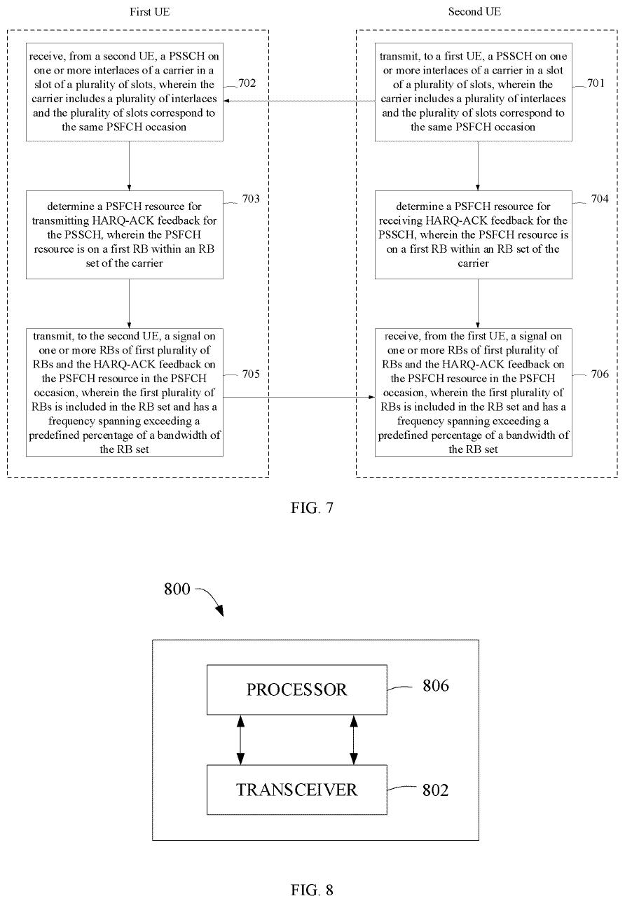

FIG. 7 illustrates a flow chart of an exemplary method for PSFCH transmission according to some embodiments of the present disclosure. The method illustrated in FIG. 7 may be performed by a first UE and a second UE. The first UE may be an Rx UE receiving a PSSCH from another UE, and may also be a PSFCH transmitting UE. The second UE may be a Tx UE transmitting a PSSCH to one or more other UEs, and may also be a PSFCH receiving UE. Although the method is illustrated in a system level, persons skilled in the art can understand that the method implemented in the two UEs can be separately implemented and incorporated in other apparatus with the like functions.

Referring to FIG. 7, in step 701, the second UE may transmit a PSSCH (e.g., denoted as PSSCH #A3) to a first UE (e.g., via a unicast manner, a groupcast manner, etc.) PSSCH #A3 may be transmitted on one or more interlaces of a carrier and in a slot of a plurality of slots, wherein the carrier includes a plurality of interlaces and the plurality of slots correspond to the same PSFCH occasion. In step 702, the first UE may receive PSSCH #A3 on the one or more interlaces within an RB set of the carrier and in the slot of a plurality of slots from the second UE.

In step 703, the first UE may determine a PSFCH resource for transmitting HARQ-ACK feedback for PSSCH #A3. In step 704, the second UE may also determine a PSFCH resource for receiving HARQ-ACK feedback for PSSCH #A3. The PSFCH resource may be on an RB (e.g., denoted as RB #B2) within an RB set of the carrier, wherein the RB set may include all the RBs of the carrier.

The first UE and the second UE may use the same methods for determine a PSFCH resource for transmitting HARQ-ACK feedback for PSSCH #A3.

For example, the first UE or the second UE may determine the PSFCH resource based on the partial interlace structure in embodiment 1 or in embodiment 2.

According to some embodiments of the present disclosure, the first UE or the second UE may determine the PSFCH resource based on the partial interlace structure in embodiment 1. In such embodiments, all the descriptions in embodiment 1 may apply here. The PSFCH resource may be within an interlace (e.g., denoted as interlace #C1) of the one or more interlaces on which PSSCH #A3 is transmitted. In some embodiments, interlace #C1 is a predefined interlace of the one or more interlaces. For example, interlace #C1 may be an interlace with the lowest interlace index among the one or more interlaces on which PSSCH #A3 is transmitted.

Interlace #C1 within the RB set may include a first plurality of RBs and a second plurality of RBs. The first plurality of RBs has a frequency spanning exceeding a predefined percentage of a bandwidth of the RB set. The second plurality of RBs is used for carrying HARQ-ACK feedback for a PSSCH(s). In an embodiment, the first plurality of RBs is configured by RRC signaling or predefined. In an embodiment, the first plurality of RBs is shared among one or more UEs including the first UE for transmitting respective HARQ-ACK feedback for a PSSCH(s) in the PSFCH occasion. For example, if the one or more UEs including the first UE transmit respective HARQ-ACK feedback for a PSSCH(s) in the PSFCH occasion on the same interlace #C1, then the first plurality of RBs may be common or shared to the one or more UEs.

In some embodiments, RB #B2 may be included in the second plurality of RBs, and determining the PSFCH resource for transmitting HARQ-ACK feedback for PSSCH #A3 may include determining RB #B2 based on an index of the slot within the plurality of slots and a mapping relationship between the plurality of slots and the second plurality of RBs. An example for determining RB #B2 may refer to as FIG. 5.

In some embodiments, RB #B2 may be included in the second plurality of RBs, and determining the PSFCH resource for transmitting HARQ-ACK feedback for PSSCH #A3 may include determining the PSFCH resource based on at least one of: an index of the slot in which PSSCH #A3 is transmitted; the number of slots included in the plurality of slots; the number of RBs included in the second plurality of RBs; the number of cyclic shift pairs associated with the second plurality of RBs; a physical layer source ID associated with the PSSCH; or a member ID of the first UE in a UE group comprising the first UE and the second UE.

According to some embodiments of the present disclosure, the first UE or the second UE may determine the PSFCH resource based on the partial interlace structure in embodiment 2. In such embodiments, all the descriptions in embodiment 2 may apply here. The RB set of the carrier may include a first plurality of RBs and a second plurality of RBs. The first plurality of RBs has a frequency spanning exceeding a predefined percentage of a bandwidth of the RB set. The second plurality of RBs is used for carrying HARQ-ACK feedback for a PSSCH(s).

In an embodiment, the first plurality of RBs is configured by RRC signaling or predefined.

In an embodiment, the first plurality of RBs is shared among one or more UEs including the first UE for transmitting respective HARQ-ACK feedback for a PSSCH(s) in the PSFCH occasion. For example, if the one or more UEs including the first UE transmit respective HARQ-ACK feedback for a PSSCH(s) in the PSFCH occasion on the same carrier, then the first plurality of RBs may be common or shared to the one or more UEs.

In some embodiments, the first plurality of RBs includes at least two RBs, and the second plurality of RBs includes the remaining RBs in the RB set. The examples for the first plurality of RBs and the second plurality of RBs may refer to FIGS. 6a and 6c.

In some embodiments, the first plurality of RBs and the second plurality of RBs are spaced by a number of contiguous RBs. An example for the first plurality of RBs and the second plurality of RBs may refer to FIG. 6b.

In some embodiments, the first plurality of RBs includes a first subset of RBs and a second subset of RBs located in two edges of the RB set. An example for the first plurality of RBs and the second plurality of RBs may refer to FIGS. 6a-6c.

In some embodiments, determining the PSFCH resource for transmitting HARQ-ACK feedback for PSSCH #A3 may include determining the PSFCH resource based on at least one of: an index of the slot; the number of slots included in the plurality of slots; an index of an interlace of the one or more interlaces; the number of interlaces included in the plurality of interlaces; the number of RBs included in the second plurality of RBs; the number of cyclic shift pairs associated with the second plurality of RBs; a physical layer source ID associated with the PSSCH; or a member ID of the first UE in a UE group comprising the first UE and the second UE.

After determining the PSFCH resource for transmitting HARQ-ACK feedback for PSSCH #A3 based on the above embodiments, in step 705, the first UE may transmit, to the second UE, a signal (e.g., ACK, NACK, or any dummy bits) on one or more RBs of the first plurality of RBs and the HARQ-ACK feedback on the PSFCH resource in the PSFCH occasion.

In an embodiment, when the first plurality of RBs includes the first subset of RBs and the second subset of RBs as stated above, the one or more RBs on which the first UE transmit the signal may include at least one RB selected from the first subset of RBs and at least one RB selected from the second subset of RBs. In an embodiment, the first UE may transmit, to the second UE, a signal (e.g., ACK, NACK, or any dummy bits) on the first plurality of RBs and the HARQ-ACK feedback on the PSFCH resource in the PSFCH occasion.

In step 706, the second UE may receive a signal (e.g., ACK, NACK, or any dummy bits) on one or more RBs of the first plurality of RBs and the HARQ-ACK feedback on the PSFCH resource in the PSFCH occasion. The second UE may skip detection on the one or more RBs of the first plurality of RBs and only detect the HARQ-ACK feedback on the one or more PSFCH resources.

FIG. 8 illustrates a simplified block diagram of an exemplary apparatus according to some embodiments of the present disclosure. As shown in FIG. 8, the apparatus 800 may include at least one processor 806 and at least one transceiver 802 coupled to the processor 806. The apparatus 800 may be a UE, for example, a first UE or a second UE as stated above.

Although in this figure, elements such as the at least one transceiver 802 and processor 806 are described in the singular, the plural is contemplated unless a limitation to the singular is explicitly stated. In some embodiments of the present disclosure, the transceiver 802 may be divided into two devices, such as a receiving circuitry and a transmitting circuitry. In some embodiments of the present disclosure, the apparatus 800 may further include an input device, a memory, and/or other components.

In some embodiments of the present disclosure, the apparatus 800 may be a first UE (e.g., an Rx UE or a PSFCH transmitting UE). The transceiver 802 and the processor 806 may interact with each other so as to perform the operations with respect to the UE described in FIGS. 1-7. In some embodiments of the present disclosure, the apparatus 800 may be a second UE (e.g., a Tx UE or a PSFCH receiving UE). The transceiver 802 and the processor 806 may interact with each other so as to perform the operations with respect to the BS described in FIGS. 1-7.

In some embodiments of the present disclosure, the apparatus 800 may further include at least one non-transitory computer-readable medium.

For example, in some embodiments of the present disclosure, the non-transitory computer-readable medium may have stored thereon computer-executable instructions to cause the processor 806 to implement the method with respect to the first UE as described above. For example, the computer-executable instructions, when executed, cause the processor 806 interacting with transceiver 802 to perform the operations with respect to the first UE described in FIGS. 1-7.

In some embodiments of the present disclosure, the non-transitory computer-readable medium may have stored thereon computer-executable instructions to cause the processor 806 to implement the method with respect to the second UE as described above. For example, the computer-executable instructions, when executed, cause the processor 806 interacting with transceiver 802 to perform the operations with respect to the second UE described in FIGS. 1-7.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present disclosure, but is not used to limit the substance of the present disclosure.

1. A first user equipment (UE) for wireless communication, comprising:
at least one memory; and
at least one processor coupled with the at least one memory and configured to cause the UE to:
receive, from a second UE, a physical sidelink shared channel (PSSCH) on one or more interlaces of a carrier in a slot of a plurality of slots, wherein the carrier includes a plurality of interlaces and the plurality of slots correspond to a same physical sidelink feedback channel (PSFCH) occasion;
determine a PSFCH resource for transmitting hybrid automatic repeat request acknowledgement (HARQ-ACK) feedback for the PSSCH, wherein the PSFCH resource is on a first resource block (RB) within an RB set of the carrier; and
transmit, to the second UE, a signal on one or more RBs of a first plurality of RBs and the HARQ-ACK feedback on the PSFCH resource in the PSFCH occasion, wherein the first plurality of RBs is included in the RB set and has a frequency spanning exceeding a predefined percentage of a bandwidth of the RB set.

2. The first UE of claim 1, wherein the first plurality of RBs is included in a first interlace of the plurality of interlaces within the RB set.

3. The first UE of claim 2, wherein the first interlace within the RB set comprises the first plurality of RBs and a second plurality of RBs, and the second plurality of RBs carries the HARQ-ACK feedback for one or more PSSCHs.

4. The first UE of claim 3, wherein the first RB is included in the second plurality of RBs and is determined based on an index of the slot within the plurality of slots and a mapping relationship between the plurality of slots and the second plurality of RBs.

5. The first UE of claim 3, wherein the first RB is included in the second plurality of RBs and the PSFCH resource is determined based on at least one of:
an index of the slot;
a first number of slots included in the plurality of slots;
a second number of RBs included in the second plurality of RBs;
a third number of cyclic shift pairs associated with the second plurality of RBs;
a physical layer source identity (ID) associated with the PSSCH; or
a member ID of the first UE in a UE group comprising the first UE and the second UE.

6. The first UE of claim 1, wherein the RB set comprises the first plurality of RBs and a second plurality of RBs, and the second plurality of RBs carries the HARQ-ACK feedback for one or more PSSCHs.

7. The first UE of claim 6, wherein the first plurality of RBs includes at least two RBs, and the second plurality of RBs includes one or more remaining RBs in the RB set.

8. The first UE of claim 6, wherein the first plurality of RBs and the second plurality of RBs are spaced by a number of contiguous RBs.

9. The first UE of claim 6, wherein the first plurality of RBs includes a first subset of RBs and a second subset of RBs located in two edges of the RB set, wherein the one or more RBs includes at least one RB selected from the first subset of RBs and at least one RB selected from the second subset of RBs.

10. The first UE of claim 6, wherein the first RB is included in the second plurality of RBs and the PSFCH resource is determined based on at least one of:
a first index of the slot;
a first number of the slots included in the plurality of slots;
a second index of an interlace of the one or more interlaces;
a second number of the interlaces included in the plurality of interlaces;
a third number of the RBs included in the second plurality of RBs;
a fourth number of cyclic shift pairs associated with the second plurality of RBs;
a physical layer source identity (ID) associated with the PSSCH; or
a member ID of the first UE in a UE group comprising the first UE and the second UE.

11. The first UE of claim 1, wherein the first plurality of RBs is shared among one or more UEs including the first UE for transmitting respective HARQ-ACK feedback for one or more PSSCHs in the PSFCH occasion.

12. A second user equipment (UE) for wireless communication, comprising:
at least one memory; and
at least one processor coupled with the at least one memory and configured to cause the UE to:
transmit, to a first UE, a physical sidelink shared channel (PSSCH) on one or more interlaces of a carrier in a slot of a plurality of slots, wherein the carrier includes a plurality of interlaces and the plurality of slots correspond to a same physical sidelink feedback channel (PSFCH) occasion;
determine a PSFCH resource for receiving hybrid automatic repeat request acknowledgement (HARQ-ACK) feedback for the PSSCH, wherein the PSFCH resource is on a first resource block (RB) within an RB set of the carrier; and
receive, from the first UE, a signal on one or more RBs of a first plurality of RBs and the HARQ-ACK feedback on the PSFCH resource in the PSFCH occasion, wherein the first plurality of RBs is included in the RB set and has a frequency spanning exceeding a predefined percentage of a bandwidth of the RB set.

13. The second UE of claim 12, wherein the first plurality of RBs is included in a first interlace of the plurality of interlaces within the RB set.

14. The second UE of claim 12, wherein the RB set comprises the first plurality of RBs and a second plurality of RBs, and the second plurality of RBs carries the HARQ-ACK feedback for one or more PSSCHs.

15. A method performed by a first user equipment (UE), the method comprising:
receiving, from a second UE, a physical sidelink shared channel (PSSCH) on one or more interlaces of a carrier in a slot of a plurality of slots, wherein the carrier includes a plurality of interlaces and the plurality of slots correspond to a same physical sidelink feedback channel (PSFCH) occasion;
determining a PSFCH resource for transmitting hybrid automatic repeat request acknowledgement (HARQ-ACK) feedback for the PSSCH, wherein the PSFCH resource is on a first a resource block (RB) within an RB set of the carrier; and
transmitting, to the second UE, a signal on one or more RBs of a first plurality of RBs and the HARQ-ACK feedback on the PSFCH resource in the PSFCH occasion, wherein the first plurality of RBs is included in the RB set and has a frequency spanning exceeding a predefined percentage of a bandwidth of the RB set.

16. The method of claim 15, wherein the first plurality of RBs is included in a first interlace of the plurality of interlaces within the RB set.

17. The method of claim 16, wherein the first interlace within the RB set comprises the first plurality of RBs and a second plurality of RBs, and the second plurality of RBs carries the HARQ-ACK feedback for one or more PSSCHs.

18. The method of claim 17, wherein the first RB is included in the second plurality of RBs and is determined based on an index of the slot within the plurality of slots and a mapping relationship between the plurality of slots and the second plurality of RBs.

19. The method of claim 15, wherein the RB set comprises the first plurality of RBs and a second plurality of RBs, and the second plurality of RBs carries the HARQ-ACK feedback for one or more PSSCHs.

20. A method performed by a second user equipment (UE), the method comprising:
transmitting, to a first UE, a physical sidelink shared channel (PSSCH) on one or more interlaces of a carrier in a slot of a plurality of slots, wherein the carrier includes a plurality of interlaces and the plurality of slots correspond to a same physical sidelink feedback channel (PSFCH) occasion;
determining a PSFCH resource for receiving hybrid automatic repeat request acknowledgement (HARQ-ACK) feedback for the PSSCH, wherein the PSFCH resource is on a first resource block (RB) within an RB set of the carrier; and
receiving, from the first UE, a signal on one or more RBs of a first plurality of RBs and the HARQ-ACK feedback on the PSFCH resource in the PSFCH occasion, wherein the first plurality of RBs is included in the RB set and has a frequency spanning exceeding a predefined percentage of a bandwidth of the RB set.
